(19) United States
(12) Patent Application Publication
(10) Pub. No.: US 2009/0070865 A1
(43) Pub. Date: Mar. 12, 2009

(54) Security proxy service

(76) Inventors: Robert Cahn, Carmel, NY (US); Carol A. Micken, Flagler Beach, FL (US)

Correspondence Address: Wendy W. Koba, PO Box 556, Springtown, PA, 18081, US

(21) Appl. No.: 12/072,237

(22) Filed: Feb. 25, 2008

Related U.S. Application Data
(60) Provisional application No. 60/993,143, filed on Sep. 10, 2007.

(51) Int. Cl. G06F 15/16

(52) U.S. Cl. 726/12

(57) ABSTRACT

A secure proxy service has been developed to authorize pre-defined individuals (defined as a “Security Agent”) to gain access to otherwise privileged information/premises when an individual has “gone missing”. The individual subscribing to the service defines and retains control of various factors such as: the time period to trigger the proxy service (i.e., missing for several days, missing for several weeks, etc.), the types of information to be accessed (i.e., only email, both premises and email, bank accounts, etc.), and the like. Once activated, the proxy allows the authorized individual(s) to gain access to the person's residence, computer accounts, bank accounts, etc. (via previously-executed “power of attorney” documents, when necessary) in an attempt to find clues regarding the missing person's location.

### CROSS-REFERENCE TO RELATED APPLICATIONS

This application claims the benefit of U.S. Provisional Application No. 60/993,143, filed Sep. 10, 2007.

### TECHNICAL FIELD

The present invention relates to a security proxy service and, more particularly, to a security proxy service to trigger the ability for a pre-defined party to gain access to otherwise protected information/residences.

### BACKGROUND OF THE INVENTION

If you live alone, are away at an educational institution or are frequently away from your family and fall out of contact with them, your family may find that legal “privacy concerns” prevent them from searching for indicia as to your whereabouts and wellbeing. Indeed, college students have disappeared and their parents have been barred from entering their room, gaining access to their email or checking an IM account—inasmuch as the parents have no legal standing to perform such activities. Universities cannot legally grant such access (or may have concerns about violating privacy rights of a student that causes them to act cautiously in situations when immediate action is required). As a result, individuals may remain in danger in situations where time is of the essence, and those who care the most are impeded in their attempts to track them down. The present invention addresses the inherent tension between the competing rights and interests of privacy and personal safety to resolve them expeditiously when needed.

There are a number of documents in common use whereby one person, referred to herein as the “principal,” grants legal authority to one or more other persons, referred to herein as the “agent,” the power and right to perform actions on behalf of the principal. Such documents, referred to herein as “authorizing documents,” include, but are not limited to, financial powers of attorney, medical powers of attorney, living wills, HIPAA authorizations, testamentary wills, and trusts. A financial power of attorney enables an agent designated by the principal to engage in and execute financial transactions of the types stipulated in the financial power of attorney on behalf of the principal. Other terms commonly used to refer to a financial power of attorney include, but are not limited to, “general power of attorney,” “durable power of attorney for finances,” “financial enduring power of attorney,” “financial statutory power of attorney,” and “commercial power of attorney.”

A medical power of attorney authorizes an agent to make medical decisions regarding the care of the principal upon the incapacity of the principal. Other terms commonly used to refer to a medical power of attorney include, but are not limited to, “durable power of attorney for health care,” “health care surrogate,” “health care proxy,” and “medical enduring power of attorney.” A living will expresses the principal's directives to medical professionals regarding the use of extraordinary medical measures should the principal be incapacitated and diagnosed with a terminal illness or irreversible condition whereby the principal will not live without such extraordinary medical measures. Other terms commonly used to refer to a living will include, but are not limited to, “advance directive,” “medical directive,” and “directive to physicians.” A HIPAA authorization authorizes a medical professional to release and to discuss with an agent medical information covered by the Health Insurance Portability and Accountability Act of 1996, “HIPAA,” regarding a principal.

A testamentary will authorizes an agent, commonly referred to as an “executor,” “executrix,” or “personal representative,” to settle the estate of the principal and follow the instructions contained in the testamentary will upon the death of the principal. Other terms commonly used to refer to a testamentary will include, but are not limited to, “last will and testament” and “will.” A trust enables an agent, commonly referred to as a “trustee,” designated by the principal to engage in and execute financial transactions of the types stipulated in the trust involving assets contained in such trust.

U.S. Pat. No. 5,241,466, issued to Perry et al. attempts to address the risk that an authorizing document will not be available when needed. Perry et al. describe a central depository for storage and retrieval of documents such as living wills, durable powers of attorney, testamentary wills, authorization for organ and bone marrow donation, and insurance information. While the patent issued to Perry et al. describes a useful system for the limited types of authorizing documents addressed therein, a number of problems concerning the use of authorizing documents still exist.

While this technique and others may be used to protect certain important documents, there remains the problem of gaining access in other circumstances, such as gaining entrance to a residence.

### SUMMARY OF THE INVENTION

The present invention addresses the needs remaining in the prior art and, in particularly, is directed to a security proxy service to trigger the ability for a pre-party defined to gain access to otherwise-protected information/residences.

In accordance with the present invention, the novel proxy service will monitor your whereabouts and will authorize pre-defined individuals (defined as a “Secuirty Agent”) to gain access to otherwise privileged information/premises. The individual subscribing to the service defines and retains control of various factors such as: the time period to trigger the proxy service (i.e., missing for several days, missing for several weeks, etc.), the types of information to be accessed (i.e., only email, both premises and email, bank accounts, etc.), and the like.

Other and further features and advantages of the present invention will become apparent during the course of the following discussion and by reference to the accompanying drawings.

### DESCRIPTION OF DRAWINGS

Referring now to the drawings

FIG. 1 contains a flow chart showing the various steps that are initially performed in order to enroll with the inventive security proxy service of the present invention; and

FIG. 2 contains a flowchart showing the process used by the security proxy service to monitor a registered subscriber and trigger a search process.

### DETAILED DESCRIPTION

The present invention describes a particular type of proxy service that may be utilized to allow selected individuals to access your private/privileged residence(s), accounts and other sources of information in order to determine your physical whereabouts and if you are in imminent danger. That is, if you are defined as “missing” after a predetermined period of time (which you define as part of the service), various previously-executed documents are delivered to an identified “security agent” (usually another family member) so that they have the necessary legal permissions to access your information and try to find you.

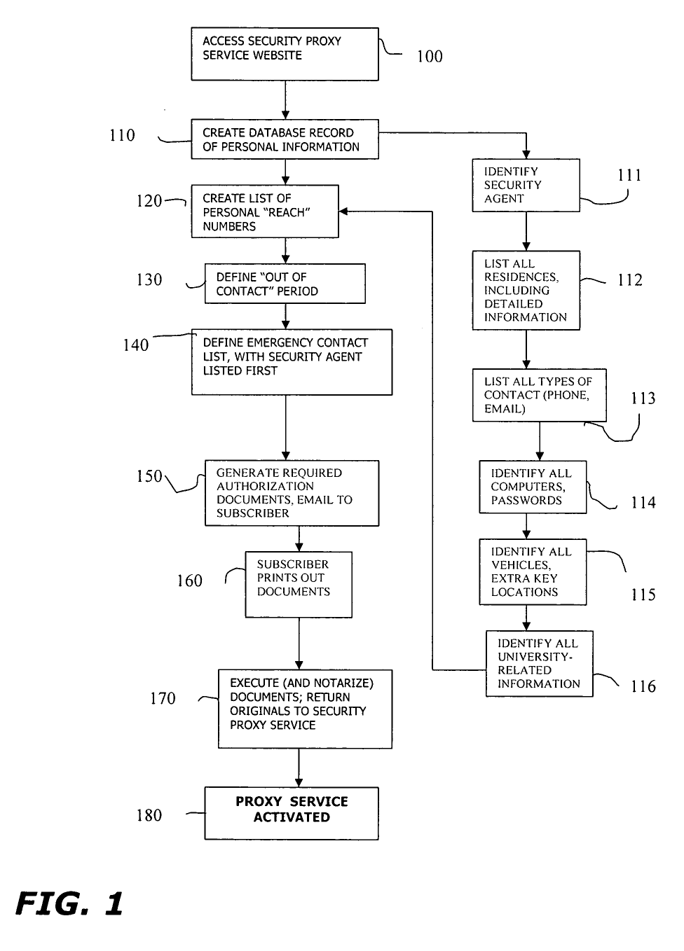

FIG. 1 contains a flow chart showing the various steps that are initially performed in order to enroll with the inventive security proxy service of the present invention. An important aspect of the inventive service is that the initial contact between a potential subscriber and the service provider may occur over the Internet (using a secure connection). Referring to step 100 in FIG. 1, the initial step is defined simply as accessing the website associated with the security proxy service provider. Upon recognizing an interest in subscribing to the service, the potential subscriber will be prompted to provide various types of personal information that will be used to establish the account with the service provider (step 110).

Also shown in the flowchart of FIG. 1 is an exemplary set of substeps that may be followed to perform the step of providing the personal information. Referring to this subset, the process begins with identifying an individual that will take on the responsibility of being the subscriber's “Security Agent” (step 105). As will be discussed in detail below, the Security Agent is defined as the individual to whom the authority is given to access personal information/locations in order to track down a missing subscriber. The choice of the person to act as Security Agent is the single most important part of the process. That person must be someone trusted by the subscriber and has his/her confidence. They will act to locate the subscriber if he/she falls out of contact. They need to be someone willing to travel if necessary to where the subscriber lives, and have the time and resources necessary to follow through on any search. Exemplary choices for Security Agent include, but are not limited to, a parent, grandparent, brother, sister, child, aunt, uncle, cousin, lifelong friend, business partner.

In accordance with the inventive service, the subscriber will be prompted to supply rather detailed information about his/her selected Security Agent, inasmuch as the service must be able to contact this person in an emergency situation. It is to be understood that sensitive information will be encrypted to protect the subscriber. Table 1 contains an exemplary listing of the type of information that may be required.

TABLE 1

| | |
|---|---|
| Name | John Q Doe |
| Address | 555 Main Street |
| City | Poughkeepsie |
| State | NY |
| Zip | 10555 |
| Phone | 845-555-0000 |
| Email | jqd111@aol.com |
| FAX | 845-556-0000 |
| Work Number | 914-555-1111 |
| Work Email | jqd@verizon.com |
| Comments | When John is taking care of his mother he can be reached |
| | at 818-444-2222. Sometimes he doesn't get his messages |
| | so try there. |

Once the subscriber has entered all of the necessary information associated with his/her selected Security Agent, the subscriber will be prompted to enter detailed personal information, beginning with residence information (step 112). In instances where the subscriber has more than one residence (such as a college student with campus address and home/summer address or an individual with a weekday home and a weekend/vacation home), the subscriber will be prompted to provide detailed information about each residence location. Table 2, below, contains an exemplary listing of the type of information that may be requested.

TABLE 2

| Residence | Residence | | Landlord | Landlord Phone |
|---|---|---|---|---|
| Name | Address | Phone Number | Address | Number |
| Home | 123 Main St | 845-279-1111 | Fred Jones | 845-225-2222 |
| | Brewster, NY | | 1445 Route 6 | |
| | 10509 | | Carmel, NY 10512 | |
| Pied-a-terre | #6a 300 W 12 Street | 212-675-3333 | Uber Mgmt. | 212-456-4444 |
| | NY, NY 10014 | | 556 Madison Ave | |
| | | | NY, NY 10021 | |

For each defined residence, the subscriber is then prompted for additional detail of the type shown in Table 3. Obviously, the degree of detail that can be provided will impact the thoroughness of a search that could be performed, if ever needed.

TABLE 3

| | |
|---|---|
| Residence Name | Home |
| Neighbor | Ed Jones |
| Neighbor Address | 125 Main St, Brewster NY 10509 |
| Neighbor Phone | 845-279-5555 |
| Neighbor email | ejones@aol.com |
| Neighbor has key | Yes |
| Building Super | No |
| Super Phone | |
| Super email | |
| Mailbox key | With neighbor |

In today's world, everyone has a myriad of different ways that he/she can be contacted. When trying to ascertain if a subscriber is truly “missing” and may be in danger, the security proxy service of the present invention will endeavor to contact the subscriber using each mode of communication associated with the subscriber. Thus, referring to FIG. 1, the next step in the subset (step 113) prompts the subscriber to list the specifics for every type of phone/messaging service to which he/she subscribers. Table 4 (below) is illustrative of the type of information that is requested during this step.

TABLE 4

| Account | Login | Password |
|---|---|---|
| Home Voicemail | 845-678-6666 | simpleme |
| Home email | johnQdoe23@gmail.com | logmein |
| Alternate email | johnDoe56@popmail.com | reallyitsme |
| Cell Voicemail | 789-323-9292 | 765432 |
| work email | jqd@bigrig.com | workpw |
| work voicemail | 510-323-8865 | 987654 |
| | (56789) | |

Computers come with multiple layers of security. Moreover, a subscriber may have a laptop computer at his office and a desktop computer at home. In addition people may belong to multiple computer-based social and networking sites for various groups of family, friends and activities which do not overlap and of which the Security Agent may not be aware. All of these computers and networking sites are protected by multiple passwords. In order to allow the identified Security Agent to gain access to information stored on these devices, the subscriber needs to supply his Security Agent with the information needed to locate, boot, and logon to the computers (step 114). Obviously, this information will need to be updated at the service provider website as it changes. A sample of computer security information is shown in Table 5-1 below, with exemplary networking security information shown in Table 5-2:

TABLE 5-1

| | | “Power on” | | |
|---|---|---|---|---|
| Computer | Location | password | Login Name | Login PW |
| Laptop | Usually at | none | JD | secret |
| | home or car | | | |
| Desktop | Home | zigzag | JDH | realsecret |

TABLE 5-2

| Service Type | URL | User Name | Password |
|---|---|---|---|
| Email | www.gmail.com | jdoe 113 | secret1 |
| Dating site | www.match.com | bigjohn | secret2 |
| Social networking | www.facebook.com | johnnyboy | secret3 |
| IM | www.aim.com | happyjohn | secret4 |

Various other types of information may be requested by the security proxy service provider; the listings shown in the above tables and the steps within the subset of the flowchart of FIG. 1 are considered to be only exemplary and not exhaustive. Indeed, it may be useful to supply to the service provider the type(s) of vehicle(s) owned by the subscriber (step 115). Table 6-1 is illustrative of this type of vehicle information.

TABLE 6-1

| | | | | | Location of |
|---|---|---|---|---|---|
| Make | Model | Color | State | License | Spare Key |
| Mazda | 6i | Blue | NY | ABC 0123 | ice tray in freezer |
| Harley- | EasyGlide | Yellow | NY | YZ 9876 | toolbox in garage |
| Davidson | | | | | |

A security agent may also wish to access bank account information associated with a subscriber, particularly to ascertain if there has been any ‘unusual’ activity associated with a bank account, credit card, or the like. Table 6-2 includes an exemplary listing of this banking information

TABLE 6-2

| Provider | Account Type | Account Number | Password |
|---|---|---|---|
| PNB Financial | Checking, with debit | 1234-56789 | wordpass |
| | card | | |
| PNB Financial | VISA | 987-34-567 = 6079 | |
| BIGBANK | Savings Account | 333-44444 | |
| BIGBANK | AMEX | 444-33-555-66666 | |

If the subscriber is a student at a post-secondary school, such as a college or university, the Family Educational Rights and Privacy Act (FERPA) grants special rights to students, regardless of their age, and treats them with the legal status of ‘adult’. Given the impact of FERPA, the service of the present invention will allow for the collection of college-related information, such as the type of information shown below in Table 7, to allow for the agent to legally interact with the post-secondary institution, when necessary (step 116).

TABLE 7

| College Information | Value |
|---|---|
| Institution Name | NYU |
| Institution Address | 30 E 12 Street |
| Institution City | New York |
| Institution State | New York |
| Institution Zip Code | 10013 |
| Student ID Number | D1234567 |
| Residence Location | 321A Founders Hall |
| Residence Telephone | 212-555-7890 |
| Residence Telephone Voicemail Password | 1212345 |
| Administration Telephone | 212-555-8888 |
| Campus Police Telephone | 212-555-8899 |
| Administration Email | thedean@nyu.edu |

In use, a special power will be required (hereinafter referred to as a “FERPA form”) that directs the subscriber's university to grant access by the agent to (for example) various university facilities, computer accounts, data stored on university servers, the subscriber's class schedule, etc. It is contemplated that specific schools may create their own type of FERPA form. While the specifics of the form may vary, the intent in accordance with the present invention is to create a listing of pertinent school-related information useful to the security agent and provide a mechanism that will trigger the ability for the agent to gain access to and use this information.

Once all of the personal information has been listed, the subscriber will be prompted (step 120) to develop a list of personal contacts—people who are in regular contact with the subscriber and would be the most likely to notice that the subscriber has not been in contact with them for an extended period of time. Typical selections for the personal contact list, as shown in Table 8, include individuals such as parents, brothers and sisters, children, cousins, dorm RAs, fraternity or sorority house mothers, business partners, boyfriends or girlfriends, lifelong friends, neighbors you are close with, activity partners that you see regularly for sports, hobbies, or the like. The first name on the contact list will be the Security Agent identified by the subscriber.

TABLE 8

| | | | | | Work | Cell |
|---|---|---|---|---|---|---|
| Name | Relationship | Address | Phone | Email | Phone | Phone |
| Fred Doe | Father | 65 Elm St | 860-555- | fd123@aol.com | 860-252- | 860-344- |
| | | New Haven, Ct | 6666 | | 7777 | 1212 |
| Jill Doe | Sister | 788 3^{rd} Ave | 212-675- | JD@gs.com | 212-805- | 917-455- |
| | | NY, NY | 8888 | | 9999 | 2323 |
| | | 10018 | | | | |
| Al Froe | Friend | 45 Grant St | 415-643- | AFroe@slb.com | 510-654- | 510-566- |
| | | SF, Ca 95666 | 0000 | | 1111 | 3434 |

The next in the setup process (step 130) is associated with selecting the appropriate “out of contact” period. This period of time will most likely be different for each subscriber, as a function of his/her personal lifestyle. For example, the subscriber may be on a college sports team that has to travel out of town every week and calls home to his/her family every Sunday. If the subscriber misses a Sunday, he/she always call the next Monday. In this scenario, a proper “out of contact” period would be eight days. Alternatively, if the subscriber calls his/her mother every other day, a proper “out of contact” period could be three days. Table 9 illustrates an exemplary listing of out-of-contact period information.

TABLE 9

| | |
|---|---|
| All (3) contacts | 8 days |
| Most (2) contacts | 10 days |

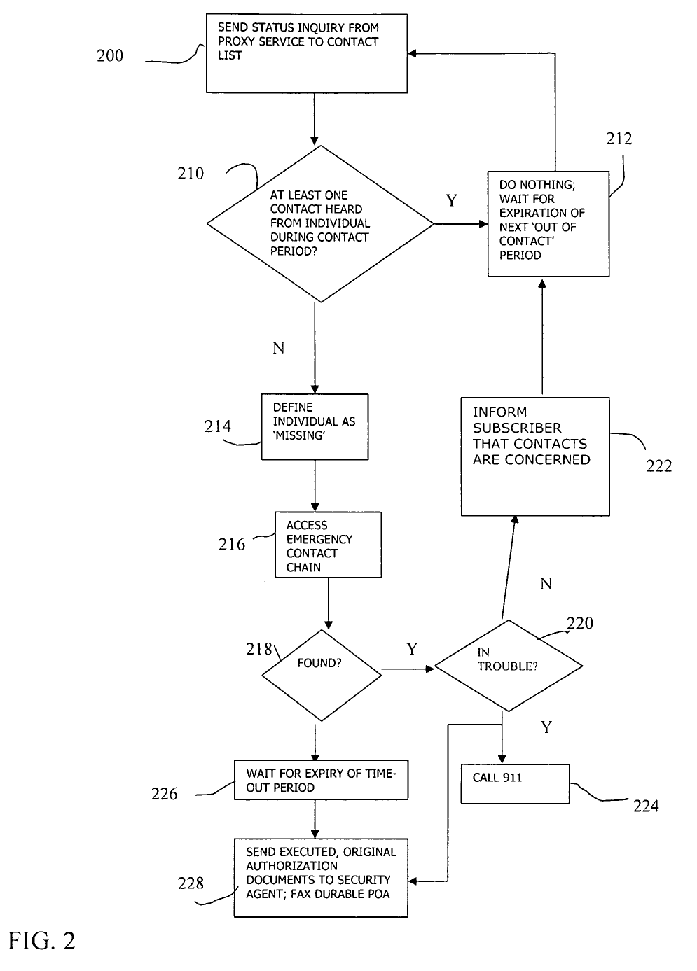

As will be described in detail below in association with the flowchart of FIG. 2, one aspect of the inventive service is that the listing of contacts will be sent an email at the end of the defined “out of contact period”, asking for a reply if they haven't heard from the subscriber. If they have been in touch with the subscriber, they can discard the emails and no further action is taken or required. Alternatively, the service may require a positive response, if only to confirm that the email has been received and acknowledged.

The next step in the process, shown as step 140, is the population of an emergency contact list, where the subscriber will define a contact list from a primary contact (the most likely number at which to reach the subscriber), and various other contacts. The list may include both phone numbers and email addresses. Table 10 is an exemplary listing of this emergency contact information.

TABLE 10

| | |
|---|---|
| Home Phone Number | 845-279-6666 |
| Work Phone Number | 914-346-7777 |
| Cell Phone Number | 917-789-8888 |
| Work Cell Number | 510-323-9999 |
| Home Email | johnQdoe23@gmail.com |
| Work Email | jqd@bigrig.com |
| Supervisor Phone Number | 510-323-1111 |
| Supervisor Email | ssj5@bigrig.com |
| Friend1 | Sarah Sue |
| Friend1 phone | 914-774-2222 |
| Friend1 email | ss1055@aol.com |

It is an important aspect of the present invention to maintain a set of executed documents that give the Security Agent the permissions legally necessary to gain access to the subscriber's information when necessary. As shown in step 150, the next step in the initial setup process is to create these documents, then transmit them electronically as text files to the subscriber, who can then print them out (step 160). These are documents that, when notarized, give a temporary power of attorney to the identified Security Agent (should the subscriber be ‘out of contact’ for his prescribed time period) to enter the subscriber's living quarters, examine his/her mail and computer accounts, check emails, use the IM, and log onto any social networking accounts. Additional documents may authorize the Security Agent to check, for example, ATM usage by credit or debit cards, or retrieve calling records from telephone companies. Each document must be signed, notarized and returned to the security proxy service (step 170) where they will be stored against need just as an attorney stores an original will. Unsigned copies should be given to the designated Security Agent so that he/she knows what they say and where to look if the subscriber goes missing. The wording of the documents will differ state by state and university by university to meet legal requirements. There will be one document per residence, account, computer and vehicle. Once documents are received, the secure proxy service is defined as “activated” for that subscriber (step 180).

FIG. 2 contains a flowchart showing the process used by the security proxy service to monitor a registered subscriber and trigger a search process. The process begins at step 200 which, as described above in conjunction with the creation of a contact list, shows the proxy service as sending an email to each of the identified persons on the contact list. At decision point 210, if the service has not received a reply email in the form of “no contact” from everyone, the process moves to step 212, where the service waits for the prescribed “out of contact” period to expire, and then return to step 200. If so described, the subscriber may request the service operate in a more passive mode, where continuous prompts regarding contact are not used and the service only responds to alerts from listed contacts.

At decision point 210, if an insufficient number of the contacts on the list have heard from the subscriber, the service proceeds to define the subscriber as “possibly missing” (step 214), and accesses the emergency contact list created by the subscriber, step 216 (see Table 10).

When the service has contacted someone claiming to be the subscriber (step 218), that person will be required to provide the proper password to verify that the person is truly the subscriber. The use of a password is to prevent someone from representing themselves as the subscriber (step 220). An exemplary set of passwords is shown in Table 11.

TABLE 7

| | |
|---|---|
| “I'm Me” Password | Snowwhite |
| “I'm In Trouble” Password | Grumpy |

If the subscriber identifies himself with “Snowwhite”, the service will then inform the subscriber that his/her contacts are concerned and should be contacted (step 222). The process then returns to step 212, waiting for the expiration of the next “out of contact” period. If the subscriber gives the password “Grumpy”, the service will contact the police (step 224) and give them the salient facts. Further, the service will provide notice to police with respect to the set of executed/notarized documents that give the security agent access to the subscriber's residence, vehicles, computers and telephones. The service will deliver these documents to the agent (step 228), where it is expected that the agent and the police will coordinate efforts to locate the subscriber. If the person contacting the service does not know either correct password, he/she will be told to contact the security agent and contacts, since they will recognize the subscriber by voice, and can quiz him/her about their condition. If the contacts are concerned that the subscriber is not free, or acting under duress, they will contact the service and provide the same result as if the person had used the “I'm in trouble” password.

Returning to step 218, if the service is unable to contact the subscriber, the process moves to step 226, waiting for the required time period to expire (a time period of, for example, 12 or 24 hours). At that point, the service will send the executed documents to the proper Security Agent, giving that person the authority to access personal residences and information (step 228).

Thus, in accordance with the present invention, the security proxy service will function to monitor a subscriber's presence and allow a selected person (“Security Agent”) to access various types of information that may be useful in locating a missing person.

It is anticipated that the Power of Attorney delivered to the Security Agent will allow them to work with authorities to locate the missing subscriber for a fixed term (e.g., 30 days, 90 days). Optionally, after this initial period has expired, the security service will deliver a second power of attorney to the Security Agent. The goal of the first power of attorney is to locate the missing person. The goal of the second power of attorney is to minimize expenses and take necessary actions in an attempt to conserve the assets of the missing person. The security agent may, for example, sell unused vehicles, terminate rental of vacant apartments, put furniture into storage, pay federal and state taxes, and the like. This second power of attorney would remain in effect until the person is located or declared legally dead.

It is intended that the foregoing detailed description be understood as an illustration of selected forms that the invention can take and not as a definition of the invention. It is only the following claims, including all equivalents, that are intended to define the scope of this invention.

What is claimed is:

1. A method of creating a proxy for use in searching for a potentially missing person in an emergency situation, the method comprising the steps of:
a) selecting a personal security agent to be authorized to perform the search;
b) providing contact information associated with the security agent;
c) preparing a database of personal information, to be accessed by the selected personal security agent during an emergency;
d) generating legal documents required to permit access to certain personal information/locations by the personal security agent;
e) creating a listing of frequent personal contacts, including contact information for each individual; and
f) defining a predetermined time period for “no contact” to be used in activating the proxy.

2. The method as defined in claim 1 wherein in performing step c), the personal information is encrypted prior to transmission to database.

3. The method as defined in claim 1 wherein the method further comprises the steps of:
g) executing the legal documents; and
h) storing the executed legal documents with the database of personal information, for access and use by the personal security agent when necessary.

4. A method of using a security proxy service in an attempt to locate a potentially missing person, the method comprising the steps of:
creating a proxy service database of personal information by:
a) selecting a personal security agent to be authorized to perform the search;
b) providing contact information associated with the security agent;
c) preparing a database of personal information, to be accessed by the selected personal security agent during an emergency;
d) generating legal documents required to permit access to certain personal information/locations by the personal security agent;
e) creating a listing of frequent personal contacts, including contact information for each individual; and
f) defining a predetermined time period for “no contact” to be used in activating the proxy;
monitoring contacts between the individual and the listing of frequency personal contacts, inquiring with the listing once during the predetermined time period of step f); and, if no contact has been made
initiating the locating service by contacting the personal security agent;
transmitting personal information from the database to the personal security agent; and
sending the executed legal documents to the personal security agent to be used in performing a search.

5. A method of creating a proxy for use in searching for a potentially missing individual-subscriber, the method comprising the steps of:
a) selecting a personal security agent to be authorized to perform the search;
b) providing contact information associated with the personal security agent;
c) preparing a database of personal information associated with the individual-subscriber, to be accessed by the selected personal security agent;
d) generating legal documents required to permit access to certain personal information/locations by the personal security agent; and
e) defining a predetermined time period for “no contact” to be used in activating the proxy.

6. The method as defined in claim 5 wherein the predetermined time period of step e) is defined by the individual-subscriber.

7. The method as defined in claim 5 wherein the predetermined time period of step e) is defined by a proxy service provider.
